(19) United States
(12) Patent Application Publication
(10) Pub. No.: US 2008/0040481 A1
(43) Pub. Date: Feb. 14, 2008

(54) METHOD AND SYSTEM FOR COMPENSATION IN AD HOC NETWORKS

(75) Inventors: Avinash Joshi, Orlando, FL (US); Thomas V. D'Amico, Inverness, IL (US); Surender Kumar, Naperville, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/464,062

(22) Filed: Aug. 11, 2006

(51) Int. Cl. G07G 1/14; G06F 15/173; G06Q 30/00

(52) U.S. Cl. 709/226; 370/310; 709/223; 705/14

(57) ABSTRACT

A system (100) and method (400) for mesh/ad hoc participation is provided. The method 400 can include compensating a first service provider (510) for allowing a device (539) of a second service provider (530) to operate in an ad hoc network (500) operated by the first service provider, and determining network resources utilized for providing communication among nodes in the ad hoc network. The compensation to the first service provider accounts for network resources utilized by the device for communicating within the ad hoc network. Resources can include equipment that is operated, owned, leased, rented, borrowed, or shared by the service provider. The method 400 allows users to roam to other networks without a service subscription agreement.

### FIELD OF THE INVENTION

The present invention relates to mobile communication systems and, more particularly, to mesh/ad hoc networking.

### BACKGROUND

Mesh networking can be an efficient and reliable way to route data, voice and instructions between nodes in a network. Mesh networking allows for continuous connections and reconfiguration within a network by allowing hopping from node to node until a connection can be established. Mesh networks are decentralized, relatively inexpensive, generally reliable, and resilient, as each node need only transmit as far as the next node. That is, nodes act as repeaters to transmit data from nearby nodes to peers that are too far away to reach, resulting in a network that can span large distances, especially over rough or difficult terrain. Mesh networks are reliable in that each node can connect to several other nodes. Mesh networks can also provide communication when a node becomes inoperable or a connection is terminated, as there are other nodes through which the data can be routed. For example, if one node drops out of the network, due to hardware failure or other reasons, the node's neighbors can search another route. Moreover, extra capacity can be installed by simply adding more nodes.

Mesh networks are generally associated with wireless networks and wired networks. For example, a Wireless LAN (WLAN) is a local area network that uses radio frequencies to communicate between wireless enabled devices. Wireless mesh networking is mesh networking implemented over a Wireless LAN. As one example, the IEEE 802.11 (“Wi-Fi”) wireless protocol can support an ad hoc networking system when no wireless access points are present. Wireless Ad hoc networks are self-forming networks and include a number of nodes which can operate with or without any fixed infrastructure. In some cases the ad hoc network can be formed entirely of mobile nodes. The nodes can be fixed or mobile and can communicate with each other over a wireless media with or without the support of an infrastructure-based or wired network. Nodes may operate in two modes in an ad hoc network i.e. an infrastructure mode and a peer mode. In infrastructure mode, typically only one communication hop is used from a mobile node to an access point (AP) or other base station (i.e. a special node with an infrastructure connection). In the peer mode, devices can manage themselves without the need for central control, such as a wireless access point. For example, a wireless connection can be established for the duration of a session without connection through a wireless access point. Instead, devices can discover other devices within range to form a wireless network for those devices. Devices may search for target nodes that are out of range by flooding the network with broadcasts that are forwarded by each node. For example, devices can communicate directly with one another making connections with one another over multiple nodes (multihop ad hoc network) without a wireless access point.

Nodes within a private mesh network are motivated to cooperate as the users have a common and private purpose. For example, emergency dispatch operator share communication resources to fulfill a common cause, such as responding to a disaster event. In a commercial mesh network, however, users may not have a common collective purpose. In commercial settings, users typically would like to gain maximum benefits from the network while incurring minimum fees. For example, a user may want to receive high volume data for internet services but not want to expend battery power providing internet services to other users. Accordingly, users within a commercial network may not be motivated to allow their device to forward packets for others nodes as the act of forwarding the nodes consumes the user's device power. For instance, a node within a mesh network may be a portable device such as a cell phone or media player. A user of the portable device may receive data from the mesh network for personal use, or forward data from other devices within the mesh network for the benefit of other users. Understandably, the portable device may have limited battery resources and the user may want to limit the amount of data that does not provide direct user benefit. Thus, the user may elect not to forward any packets for other users if it does not benefit the user.

Mesh/ad hoc networks also allow for the creation of ad hoc communities wherein information can be widely shared. Wireless community networks provide creative ways of accessing the Internet, promote ubiquitous access to inspire wireless applications and software, publish community ideas and specifications openly, and help others create local wireless communities. The wireless networks may take advantage of the relatively affordable, standardized 802.11b (Wi-Fi) devices to build growing clusters of linked, citywide networks. The wireless community networks can be linked to the wider Internet, particularly where individuals can obtain unmetered internet connections such as ADSL and/or cable modem at fixed costs and share them with friends.

Wireless Mesh/ad hoc networks are generally based on a wireless network operator or service provider business model where a user subscribes to a particular service. Competition generally exists between operators at the subscription level. For example, users must usually enter into a long term contract for one network. Also, although it is possible for a user to roam to a different network, roaming is usually based on agreements between the operators. Furthermore, system level resources required for roaming are generally burdened by significant cost premiums. The service providers generally provide the equipment and the infrastructure to support communication. They may also provide equipment to wireless communities building mesh/ad hoc networks at a discount. In a wireless mesh/ad hoc network, the users may be able to sufficiently provide communication services to one another without relying on the service provider. However, if the users compensate each other for forwarding traffic there can be cases where they can form independent networks without paying any fee to the service provider.

The advent of ad hoc networks and wireless communities introduces new service aspects wherein users may provide assistance to one another, either with or without wireless network operator assistance. The ad hoc community may involve various service providers each having subscription requirements. However, users may be hesitant to join ad hoc communities for various reasons. Moreover, the service providers may not be aware of the communication resources used or shared by those devices joining the mesh/ad hoc network. Accordingly, a need exists for encouraging users to be a part of an ad hoc network, compensating users for allowing their device to be a shared resource, compensating network operators for providing equipment and infrastructure, and allowing users to roam to different networks without a service subscription. Moreover, the need should be implemented in a manner that is resourceful and financially beneficial to both users and operators.

### SUMMARY

One embodiment of the invention is directed to a method for mesh/ad hoc participation. The method can include compensating a first service provider for allowing a device of a second service provider to operate in an ad hoc network operated by the first service provider, and determining network resources utilized for providing communication among nodes in the ad hoc network. The compensation to the service provider can account for network resources utilized by the device for communicating within the ad hoc network. The network resources can include equipment that is operated, owned, leased, rented, borrowed, or shared by the service provider, or equipment provided to users, or is equipment owned by a user that is provided on a contract basis by the service provider. As an example, the equipment can be a radio, cell phone, base station, router, access point, server, or other infrastructure equipment. Credits can be distributed to a plurality of service providers based on an amount of resources used by the device that are operated by the service providers as an incentive. The service providers can exchange the credits with users operating devices of other service providers in the ad hoc network they are operating or with other service providers.

In one arrangement, a number of packets forwarded and originated by the device can be determined. The credits can be distributed to the service providers based on network resources used for forwarding packets and originating packets. For example, a user can be charged based on a number of packets the device of the user generates or receives for the service provider. Micro-payments can also be provided by devices in the ad hoc network to intermediary and destination nodes involved in relaying packets within the ad hoc network. The micro-payment can be attached to a packet, sent with the packet, collected by the intermediary and destination nodes, and reported to the service provider. In one arrangement, a cost of a network service incurred by the device can be included in the micro-payment. In one aspect the micro-payment can be redeemed for cash. In practice, routing information can be included within the micro-payment for allowing a service provider to determine what equipment has been utilized in forwarding the packet through the ad hoc network. The service provider can determine the amount of resources utilized for communicating the packet in the ad hoc network based on the routing information and receive compensation based on the resources utilized. Moreover, the route can be determined by evaluating a cost associated with the compensation to other nodes for providing communication support. In one aspect, the cost is a credit charged by the nodes providing communication support.

Another embodiment of the invention is directed to a method for compensation in an ad hoc network. The method can include determining whether a first device of a first service provider is communicating through a second device of a second service provider, charging the first service provider of the first device for allowing the first device to operate through the second device, and compensating the second service provider for allowing the second device to provide communication assistance to the first device. The charging and compensating can allow users to roam to different networks in the ad hoc network without a service subscription to the different networks. For example, a first user of the first device can be charged for communicating through the second device. The charge can be conveyed to the first service provider. A user of the second device can be credited for allowing the second device to be used to provide communication assistance for the first device. The credit can be conveyed to the second service provider, which can correspond to a charge subject to the first user. In one arrangement, credits accumulated by a first user can be provided to a second service provider for allowing a first user to roam to different networks in the ad hoc network without a service subscription to the different networks.

In another arrangement, a determination can be made as to whether the device is operating in peer mode or infrastructure mode. If the device is operating in peer mode, the device can limit a number of packets which the node sends and a number of packets the node forwards. If the device is operating in infrastructure mode, the device can limit a number of packets which the node sends but not limit a number of packets the node forwards. Infrastructure credits can be provided to the device for forwarding packets in infrastructure mode. Peer credits can be provided to the device for forwarding packets in peer mode. An exchange rate can be established between the infrastructure credits and the peer credits. Credit can be provided in the form of additional data capacity for sending or receiving packets based on an exchange rate of credit.

Embodiments of the invention are also directed to a method for providing an incentive to a user in an ad hoc network. An incentive can include credits that are offered to the user and which can be exchanged with other users, or service providers. The method can include determining a device used for communicating data between nodes in an ad hoc network, and crediting a user of the device for allowing the device to be used to provide communication. Users can compensate one another for providing communication assistance. For example, a first user can credit a second user for allowing a first device of the first user to communicate data using a second device of the second user. In one arrangement, credits accumulated by a user can be offered to a service provider for allowing the user to roam to different networks in the ad hoc network without a service subscription to the different networks.

In another arrangement, connectivity nodes in the ad hoc network receiving network connectivity can be identified. Dependent nodes in the ad hoc network receiving network connectivity through the connectivity nodes can also be identified. Connectivity nodes can be offered credits to remain connected in the ad hoc network for providing communication to the dependent nodes. For example, a user that is dependent on other devices in the network can offer credits to the devices for remaining connected, thereby allowing the user to remain connected.

As an example of an incentive, a billing rate to the user can be adjusted by the service provider based on a participation of the device in the ad hoc network. For example, the billing rate can be decreased to the user if the user allows the device to forward packets for other users. The user can be compensated for allowing resources of their device, such as battery life and bandwidth, to be used for forwarding packets. As another example of an incentive, data capacity can be sold to the user in the form of credits and a key can be provided by the service provider in response to a purchase of the data capacity. The credits can be dispensed in accordance with an infrastructure mode or an ad hoc mode. The key can be recharged based on a number of credits accumulated by the device, wherein the recharging updates the micro-payment in accordance with a number of packets the device generates and receives.

Embodiments of the invention are also directed to a system for ad hoc networking. The system can include a plurality of mobile wireless user terminals for providing at least one incentive to a service provider for allowing a user to operate a device in an ad hoc network, and distributing credits to a plurality of service providers based on an amount of resources used by the device that are operated by the service providers. The system can include at least one service provider that provides network resources for supporting the ad hoc network. The network resources can include equipment that is operated, owned, leased, rented, borrowed, or shared by the service provider. As an example, equipment can includes at least one of radios, cell phones, base stations, routers, access points, servers, and infrastructure equipment.

Embodiments of the invention are also directed to an apparatus for crediting a user in an ad hoc network. The apparatus can identify connectivity nodes in the ad hoc network receiving network connectivity, and offer the connectivity nodes credits to provide communication for the apparatus. The apparatus can determine a packet forwarding route based on a cost associated with the packet forwarding route, wherein a credit to a device for forwarding packets is a micro-payment that is attached to a packet, sent with the packet, collected by the connectivity nodes, and reported to a service provider. In one aspect, the apparatus can provide an indication of the credits the apparatus accumulates as compensation for providing communication assistance to other nodes in the ad hoc network.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a system for ad hoc wireless communications network including a plurality of nodes employing a system and method in accordance with an embodiment of the present invention;

FIG. 2 is a block diagram illustrating an example of a mobile node employed in the network shown in FIG. 1;

FIG. 3 is a method for compensating a user in accordance with an embodiment of the present invention;

FIG. 4 is a method for ad hoc networking in accordance with an embodiment of the present invention;

FIG. 5 is an embodiment for compensating a service provider in accordance with an embodiment of the present invention;

FIG. 6 is another embodiment for compensating a service provider in accordance with an embodiment of the present invention;

FIG. 7 is yet another embodiment for compensating a service provider in accordance with an embodiment of the present invention;

FIG. 8 is a method for charging users in accordance with an embodiment of the present invention;

FIG. 9 is an ad hoc network for providing micro-payments in accordance with an embodiment of the present invention; and

FIG. 10 is a method for micro-payments in accordance with an embodiment of the present invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The term “infrastructure mode” can be defined as an ad hoc network comprising at least one mobile device that is not more that one hop from a mobile node, an access point, or base station. The term “peer mode” can be defined as an ad hoc network wherein mobile devices communicate with other mobile devices without central control and are at least one hop from a mobile node, an access point, or base station.

Briefly, embodiments of the invention are directed to a method and system which encourages users and service providers to cooperate with each other by providing incentives based on the actual resources utilized for providing communication support. In one aspect, credits can be provided to devices essential for network connectivity, and nodes within the ad hoc network can decide routes based on an actual cost (e.g. credit charged by other nodes) incurred. Devices can exchange credits with each other or other service providers for roaming between different networks without a subscription. Devices can exchange credits with other devices operated by other service providers for receiving or providing a service. The devices can report actual resources used by the other devices and report the resource use to their service provider. The service providers can exchange credits with one another to allow mobile device of different service providers to operate on their networks. Credits can be based on whether a device is operating in infrastructure mode or peer mode. In another embodiment, service providers are compensated for allowing their infrastructure equipment and devices to be used in an ad hoc network. The allows a service provider to generate revenue from an ad hoc network when device are used in either ad hoc or infrastructure mode.

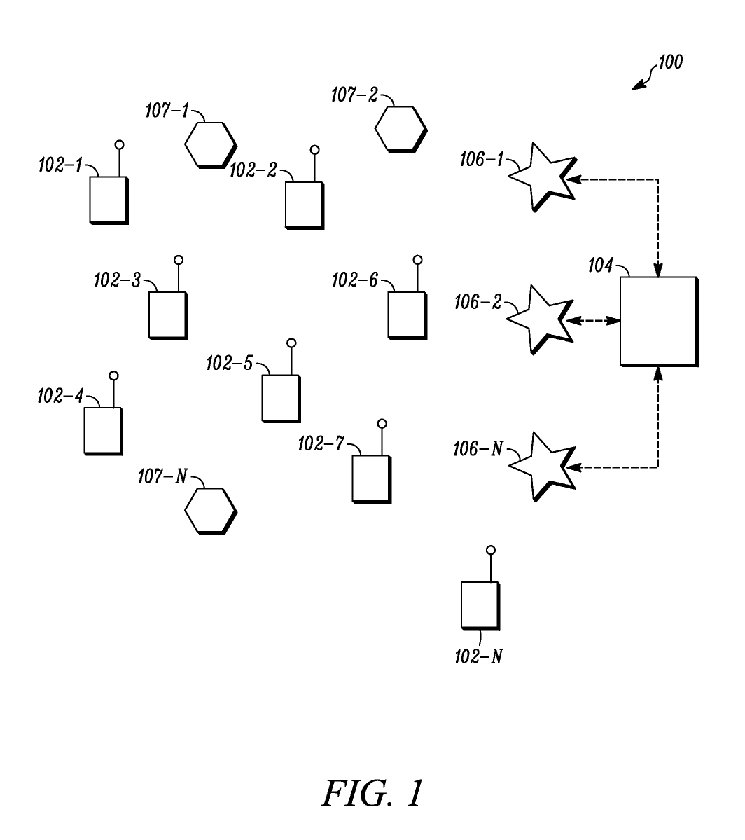

Referring to FIG. 1, a block diagram illustrating an example of an ad hoc wireless communications network 100 employing an embodiment of the present invention is shown. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106, access points (APs) 106 or intelligent access points (IAPs) 106), for providing nodes 102 with access to the fixed network 104. The fixed network 104 can include, for example, a core local area network (LAN), and a plurality of servers and gateway routers to provide network nodes with access to other networks, such as other ad hoc networks, the public switched telephone network (PSTN) and the Internet. The network 100 further can include a plurality of fixed routers 107-1 through 107-n (referred to generally as nodes 107, wireless routers (WRs) 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790, and U.S. Pat. Nos. 6,807,165 and 6,873,839.

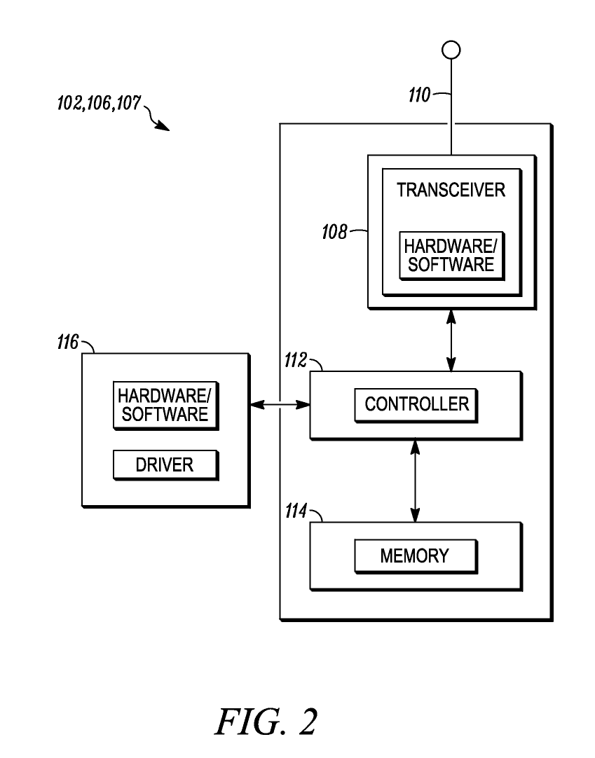

As shown in FIG. 2, each node 102, 106 and 107 includes at least one transceiver or modem 108, which is coupled to an antenna 110 and is capable of receiving and transmitting signals, such as packetized signals, to and from the node 102, 106 or 107, under the control of a controller 112. The packetized data signals can include, for example, voice, data, multimedia information, instructions, and packetized control signals, including node update information.

Each node 102, 106 and 107 further includes a memory 114, such as a random access memory (RAM) that is capable of storing, among other things, routing information pertaining to itself and other nodes in the network 100. A display 118 can also be included for presenting routing information and costs associated with using the routes. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included. The nodes 102 within the network can form a wireless ad hoc network. A node can be a mobile device, a cell phone, a radio, a portable media player, a laptop, or any other suitable communication device.

In one aspect, the controller 112 can query mobile wireless user terminals 102-n in the ad hoc network for communication capabilities, select routes within the ad hoc network based on a quality of service and packet forwarding in view of the query, and determine one or more routes based on at least one of a battery life of the mobile wireless user terminal, a communication interference of the mobile wireless user terminal in the ad hoc network, a security of the mobile wireless user terminal in the ad hoc network, or a throughput of the mobile wireless user terminal in the ad hoc network.

Ad hoc networks require the participation of many nodes for providing efficient and optimized networking. Value can be created through cooperative ad hoc networking capabilities made available by participating nodes. That is, an ad hoc network relies on the contribution of other nodes within the network to share resource loads, such as forwarding data packets. As an example, if the ad hoc network is used in a military or rescue scenario, all the nodes are generally motivated to cooperate as they have common cause. Various protocols are available which provide methods for route optimization and increase ad hoc network efficiencies. However, many users may not want to join the ad hoc network for certain reasons. For example, a user may not want to let their device, such as a mobile phone, be used to forward packets for another user. Understandably, this may reduce the battery life of the mobile device. The users are often not enticed to join an ad hoc network due to battery longevity, interference, security concerns, sharing concerns, or misinformation of device capabilities. Moreover, in commercial usage, users typically would like to gain maximum benefits from the network while paying a minimum fee. The users may not be motivated to forward packets for others as it consumes energy and drains the limited battery power. Thus, an incentive can be given to the user to encourage cooperation and forward packets for other users.

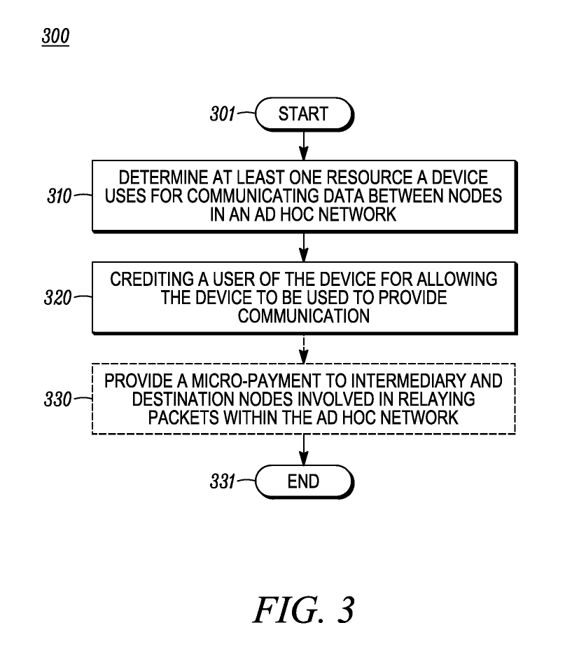

Referring to FIG. 3, a method 300 for compensating a user is shown. The method 300 may be practiced with more or less than the number of steps shown. Moreover, the method 300 is not limited to the method steps shown. The method 300 provides incentives to users for allowing their devices to become a part of the ad hoc network, so that the ad hoc network operates efficiently and optimally. The method 300 promotes collaboration, route optimization, and efficient operation of ad hoc networks. Moreover, the method 300 provides an incentive to users to participate in an ad hoc network for supporting a shared network resource environment. In particular, the method 300 can be collectively implemented by one or more of the plurality of mobile wireless user terminals 102-n shown if FIG. 1.

At step 310, at least one resource a device uses can be determined for communicating data between nodes in an ad hoc network. For example, a network resource can include a battery life, a throughout, or a security, but is not limited to these The method step 310 can determine a forwarding capacity for the mobile wireless user terminals 102-n and identify costs of resources associated with one or more routes. Briefly referring to FIG. 1, nodes 102, access points 106, and wireless routers 107, are considered network resources. As an example, nodes (e.g. devices) in the ad hoc network can be probed for communication capabilities and probed for a cost of using the communication capabilities. Routes within the ad hoc network can be presented to the user based on the cost associated with using the network resources. For example, a list of routes and associated costs can be presented in a visual screen to a user of the device.

At step 320, a user can be credited for allowing the device to be used to provide communication assistance for other nodes in the ad hoc network. The credit can be considered an incentive to the user for allowing their device to be used in the ad hoc network. By providing an incentive to users, routes can be decided based on credits provided to users. For example, a device can query other nodes in the network to determine a cost associated with using the resources of that device. For example, multiple routes may exist through the network, with each route having an associated cost of use. The cost may be in the form of battery credits, throughput credits, or security credits though is not herein limited to these. The cost can be a service fee, a cash payment, or any other suitable form of monetary or financial compensation. The cost of use may be controlled by the user or the service provider. Moreover, credits can be exchanged between users for allowing a use of their device. For example, certain users may be willing to let their device be used at a lower cost than another user's device. Accordingly, a cost of routes can be generated which identifies paths through the ad hoc network. For example, some routes may cost less because the throughput is less and the delay is longer. Some routes may be more expensive because they have low delay and can send large quantities of data. Notably, the cost can be a credit charged by a device for using the device in the ad hoc network. Moreover the routes and the associated costs can be presented to users to allow them to select a route through the network.

As an example, at step 330, the step 320 for crediting the user can include providing a micro-payment to intermediary and destination nodes involved in relaying packets within the ad hoc network. The micro-payment can be attached to a packet, sent with the packet, collected by the intermediary and destination nodes, and reported to the service provider. At step 321, the method can end.

In one aspect the compensating the user optimizes a packet routing efficiency in the ad hoc network. The method 300 can allocate credits to devices within the ad hoc network which can be redeemed for various awards, such as air-time credits, cash, or trade. In one aspect, credits can be categorized based on value, wherein a value is time-based, location-based, or context-based for providing route optimization. In another aspect, a packet routing optimization in the ad hoc network can be determined based on message types. Moreover, feedback can be provided for identifying cooperation and participation of devices in the ad hoc network. As an example, a compensation may include adjusting a billing rate to the user based on a participation of the device in the ad hoc network or adjusting an air-time value credit to the user to encourage participation in the ad hoc network and optimize the packet routing. Notably, providing incentives fosters the creation of ad hoc communities that make collaborative decisions in the ad hoc communities.

It should also be noted that service providers provide equipment for mesh/ad hoc networks. In certain cases, they may provide the equipment at a discount (or free) to subscribers for fostering ad hoc community growth. Understandably, the providers also have an incentive in receiving compensation for use of the equipment and services. In general, the cost for providing the equipment is incurred by charging a periodic service fee to the users. However, if the users form peer group communities and compensate each other for forwarding traffic there will be limited involvement or oversight from the service providers. That is, there can be cases where the users form independent networks such as peer groups and operating in peer mode without paying any fee to the service provider. Thus, service providers may not be able to recapture costs when the users operate in a peer mode.

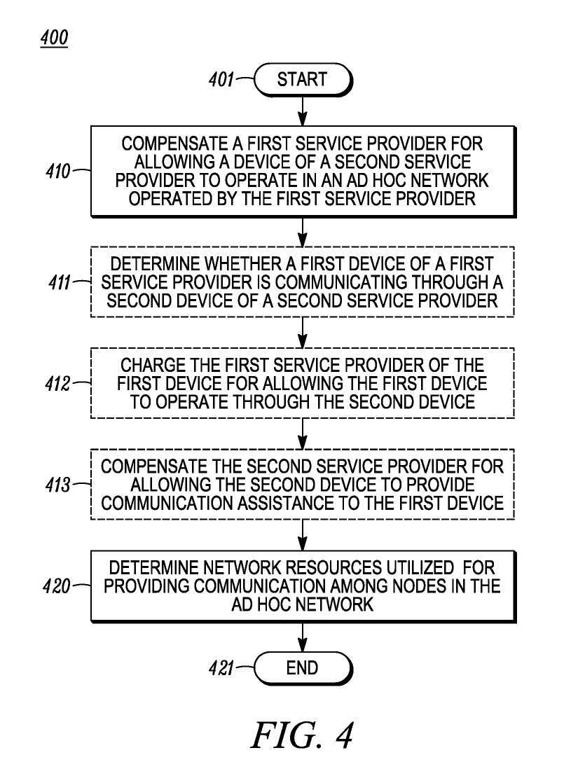

Referring to FIG. 4, a method 400 for ad hoc networking is shown. The method 400 may be practiced with more or less than the number of steps shown. Moreover, the method 400 is not limited to the method steps shown. Briefly, the method 400 allows Service Providers to compensate one another for allowing users to use a mobile device in an ad hoc network operated by another service provider. At step 410, a first service provider can be compensated for allowing a device of a second service provider to operate in an ad hoc network operated by the first service provider. For example, a step 411, a determination can be made as to whether a first device of a first service provider is communicating through a second device of a second service provider. At step 412, the first service provider of the first device can be charged for allowing the first device to operate through the second device. At step 413, the second service provider can be compensated for allowing the second device to provide communication assistance to the first device. The charging and compensating allow users to roam to different networks in the ad hoc network without a service subscription to the different networks.

The compensation to the service provider can account for network resources utilized by the device for communicating within the ad hoc network. The network resources can include equipment that is operated, owned, leased, rented, borrowed, shared by the service provider, or shared by the service provider, or equipment provided to users, or is equipment owned by a user that is provided on a contract basis by the service provider. As an example, the equipment can be a radio, cell phone, base station, router, access point, server, or other infrastructure equipment. A determination as the resources used can be accounted for. As an example, a mobile device can monitor a number of packets forwarded by a device.

At step 420, network resources utilized can be determined for providing communication among nodes in the ad hoc network. Service providers can be charged or credited based on an amount of resources used by devices operated by the service providers. As one example, service providers can exchange credits for allowing mobile devices of one service provider to operate in a network of another service provider. The service providers can exchange the credits with other service providers in the ad hoc network as compensation. In one arrangement, a mobile device can determine a number of packets forwarded and originated on behalf of other mobile device. For example, a first mobile device may provide communication assistance to a second mobile device. The first mobile device can determine the number of packets forwarded for the second device and report the useage to a service provider. A user of the second device can be charged based on a number of packets delivered to the second device by the first device. In one aspect, forwarding packets can result in credits offered to a user device and originating packets can result in credits provided from the user device.

The compensation based method 400 can be used to allow a user to roam between networks based on actual resources used and which also provides compensation to the service provider. That is, the method 400 can be extended to allow a user to roam to different networks in the ad hoc network without a service subscription to the different networks based on a credit system. Such an arrangement compensates the user based on the resources the device actually uses in the different networks, and compensates a service provider in the different networks for providing infrastructure support to the device that delivers packets in the ad hoc network.

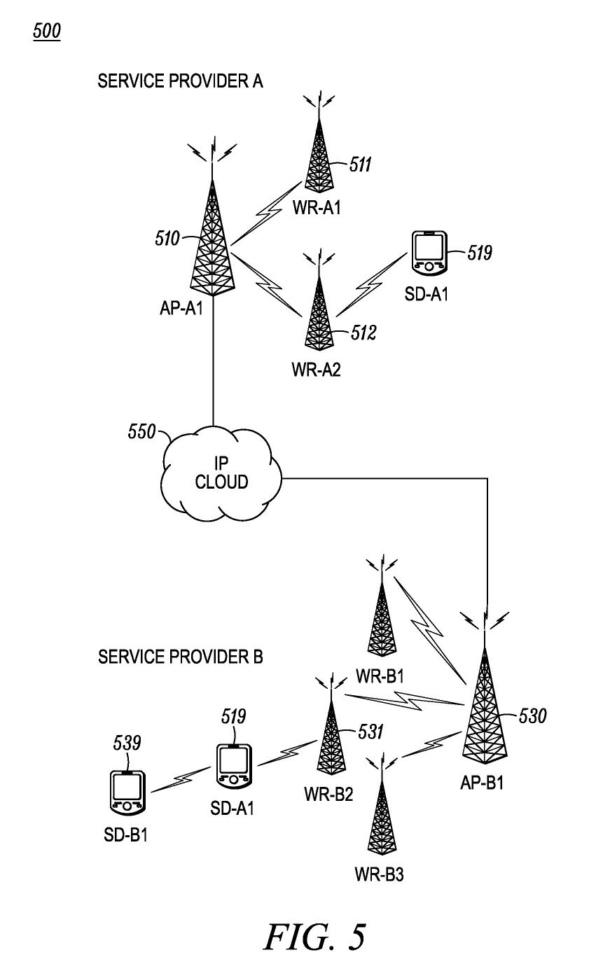

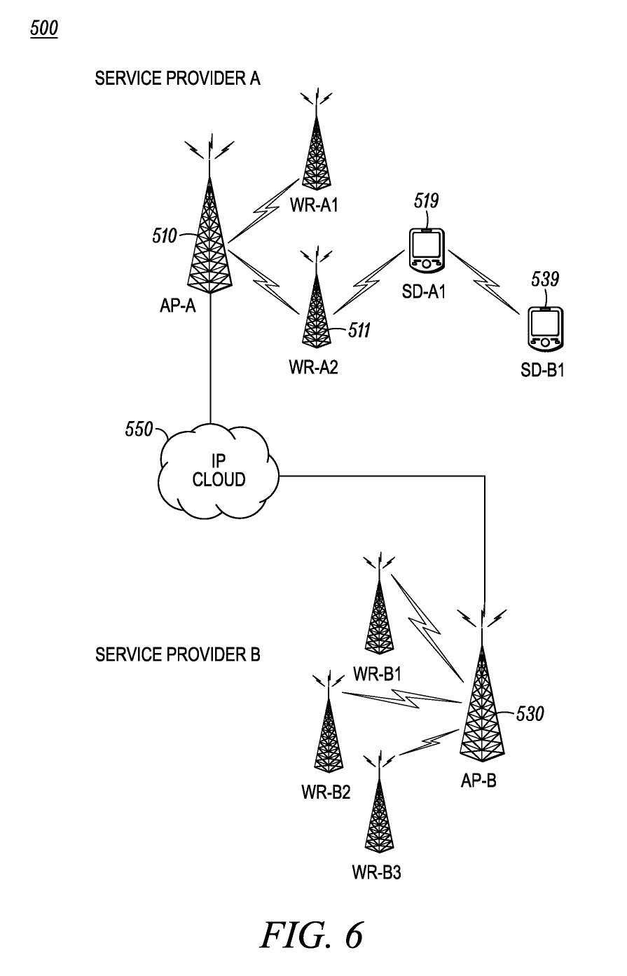

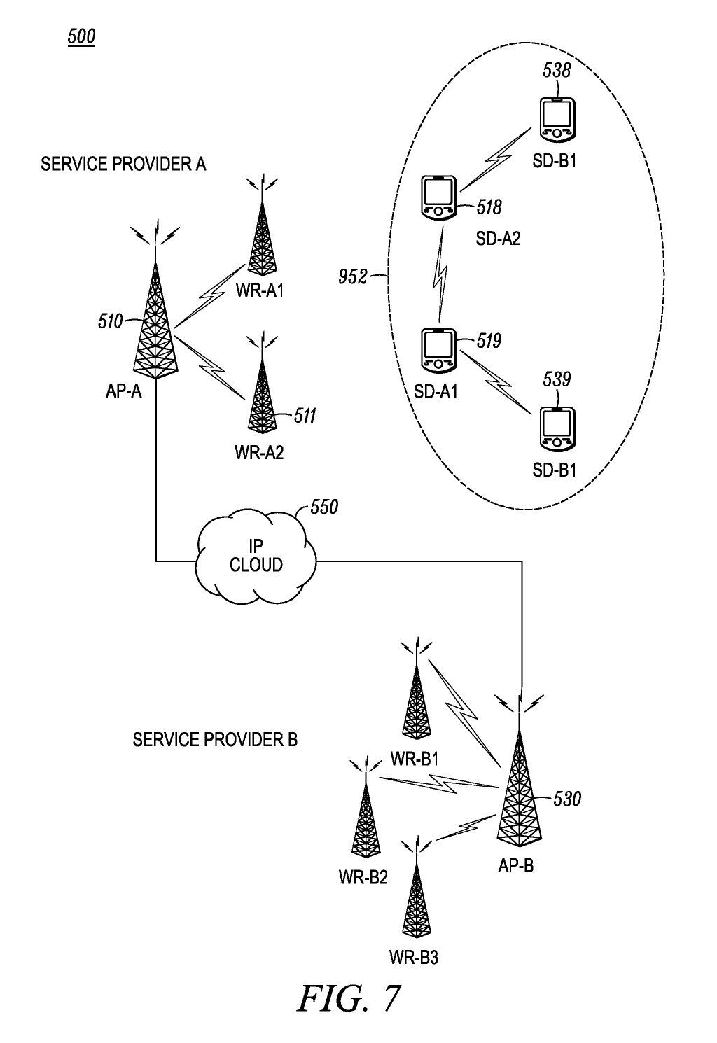

Referring to FIG. 5, one embodiment of an ad hoc network 500 implementing the method 400 of FIG. 4 for compensating a service provider is shown. Briefly the ad hoc network 500 is capable of providing communication support to devices outside an area of their service provider. The following notation has been used in FIG. 5 and is carried forward to FIGS. 6 and 7: AP-x_—Access Point belonging to ISP x, SD-x_—Subscriber Device also known as Mobile Device subscribed with ISP x, WR-x_—Wireless Router belonging to ISP x, ISP—Internet Service Provider. For example, mobile device 519 receives communication from ISP A of Access Point 510 through wireless router 511. Notably, more than the number of system components can be included for providing a coverage area.

In certain cases, mobile device 519 may leave the coverage area of ISP A and enter another service provider area. For example, mobile device 519 may enter an area operated by ISP B. Access Point 530 belonging to ISP B provides communication coverage to mobile device 519 through wireless router 531. Mobile device 519, though not a subscriber to ISP B, can still receive service through wireless router 531 of ISP B. In some cases, mobile device 539, which is a subscriber to ISP B, may not be in proximity to receive service from wireless router 531 of it's ISP B. Notably, mobile device 539 is a subscriber of ISP B though cannot receive connectivity because it is out of range. However, mobile device 519 can provide connectivity for mobile device 539 to receive communication from the wireless router 531 of ISP B. That is, mobile device 519 provides communication assistance to mobile device 539 for connecting to ISP B. Notably, mobile device 519 is a subscriber of ISP A, and is offering assistance to a mobile device 539 of ISP B.

Mobile device 519 can monitor services offered to mobile device 539 and report a usage of those services to Access Point 510 controlled by ISP A. For example, mobile device 519 can store information regarding the number of bytes forwarded to mobile device 539. Access Point 510 can then inform Access Point 530 of the resources offered by mobile device 519 and used by mobile device 539. In particular, ISP A can charge ISP B for the actual resources used by mobile device 539 based on resource information usage reported by mobile device 519. That is ISP A can charge ISP B because one of ISP A's mobile devices was involved in providing service to one of ISP B's mobile devices. Communication between ISP B and ISP A can exist over the internet protocol (IP) cloud 550. In one aspect, ISP A and ISP B can exchange credits based on the number of mobile devices supported in each of the respective networks. For example, an arrangement or agreement can be determined wherein a user of resources is accounted for using a credit and debit system. In another aspect, mobile device 539 can provide a micro-payment to mobile device 519 for using resources. The micro-payment may or may not be reported to the Access Point 510.

Referring to FIG. 6, another embodiment of an ad hoc network 500 implementing the method 400 of FIG. 4 for compensating a service provider is shown. The ad hoc network 900 is capable of providing communication support to mobile devices outside an area of their service provider. Briefly, the ad hoc network 500 illustrates a scenario wherein a mobile device of ISP B requests communication support through a mobile device of ISP A. For example, mobile device 519 is a subscriber to ISP A, and is in proximity of wireless router 511 to receive connectivity from Access Point 510 of ISP A. Mobile device 539, belonging to ISP B, is outside of range from ISP B, though is in proximity to mobile device 510. In this scenario, mobile device 510 can provide communication assistance to mobile device 539. This allows mobile device 539 to use services of ISP A while hopping through mobile device 519 of ISP A. Mobile device 519, can report the number of bytes used by mobile device 539 through wireless router 511 to Access Point 510. Notably, mobile device 519 can monitor resources used by mobile device 539 while it is operating in an area of ISP A. Access point 510 can report data capacity and resources used by mobile device 539 to Access point 530. In particular, ISP A can charge ISP B for providing service to one ISP B's subscriber; mobile device 539. In one aspect, mobile device 539 can provide a micro-payment as a charge to mobile device 519 for using resources. The micro-payment may or may not be reported to the Access Point 510.

Referring to FIG. 7, another embodiment of an ad hoc network 500 for compensating a service provider is shown. Access point 510 belongs to and is operated by the ISP A and Access Point 530 belongs to and is operated by ISP B. In particular, a service provider can be compensated for allowing non-subscriber mobile devices to use resources of subscriber mobile devices in a peer mode. For example, mobile device 518 and mobile device 519 can be mobile devices under a service agreement with ISP A. Mobile device 538 and mobile device 539 can be mobile devices under a service agreement with ISP B. Mobile device 538 and mobile device 539 may communication with one another in peer mode under peer group 952 operated by ISP A through mobile device 518 and mobile device 519. That is, mobile device 538 and mobile device 539 are communicating together through peer mobile devices 518 and 519. In one arrangement, mobile device 518 and mobile device 519 may be receiving communication assistance from Access Point 510 in the ad hoc network 500 for providing services to mobile device 538 and mobile device 539. However, mobile devices 518 and 519 can operate in non-network assisted mode such as peer mode where communications can be exchanged directly between the mobile device. For example, mobile devices in the peer group 952 may be able to communicate over short range communication such as BlueTooth (e.g. IEEE 802.15) or IEEE 802.11. In peer mode, the mobile devices in the peer group 952 may not require assistance from the Access Point 510.

Mobile device 518 and mobile device 519 can monitor the actual resources used by the non-subscriber mobile devices 538 and 539, and report the usage to Access Point 510. Consequently, ISP A can charge ISP B for resources used by mobile devices 538 and 539 operating in a service area of ISP A. Notably, ISP A and ISP B can enter an agreement for exchanging credits for resources utilized. Moreover, embodiments of the invention are not limited to the number or types of components shown. More or less than the number of system components can be included in the ad hoc network 950 for providing communication assistance to non-subscriber mobile devices. In one aspect, mobile devices 538 and 539 can provide a micro-payment to mobile devices 518 and 518 for using resources. The micro-payment may or may not be reported to the Access Point 510.

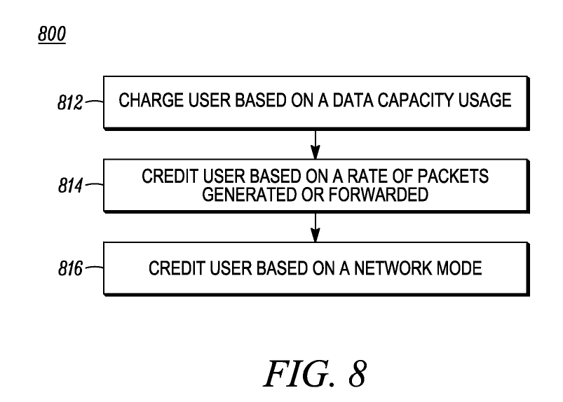

Referring to FIG. 8, a method 800 for charging a user and enabling users to roam to different networks as desired without the need for service subscriptions is shown. The method 800 builds upon the method 300 for providing an incentive to a user for joining an ad hoc network and the method 400 for compensating a service provider for providing services and equipment. In particular, the method 800 addresses aspects of method steps 412 and 413 for charging a first user and compensating a second user. The credits are beneficial to both the user and the service provider.

The method 800 can include charging (812) users based on a data capacity usage. For example, devices can be charged based on number of packets they generate or receive. As one example, referring to FIG. 1, a user of mobile device 102 can buy data capacity from an internet/phone from various providers. In one arrangement, users can buy data capacity even if they are currently outside the range of a service provider. In another arrangement users can also buy a number of bytes when they are inside a network by special software resident in a transceiver 106 (See FIG. 2) of the device. When the user buys data capacity over the network or a phone, the user can receive a key based on the number of bytes he bought. Punching this key recharges the number of bytes which can be generated/received by the device. There can be a subdivision of charges on the basis of data rate.

The method 800 can include crediting (814) users based on a rate of packets generated or forwarded. For example, referring to FIG. 1, devices 107 may be forwarding data on behalf of devices 102. Accordingly, the users of devices 107 can be credited based on the assistance the device 107 offers to devices 102. As previously presented in method 300 of FIG. 3, and in accordance with the method 400, a device can be given a credit for each packet they forward for other users. The device may also be debited for packets originating at the device. As another example, the user may be allocated air-time credits for allowing the device to forward packets on behalf of other users within the ad hoc network. Airtime value ‘credits’ can be traded between units to encourage participation in ad hoc network to optimize the route. Units with more airtime value ‘credits’ may be willing (as part of a community) to voluntarily share their air time value ‘credits’ with other units to entice joining to optimize the route.

Moreover, the users can trade air-time credits through an ad hoc bartering system available to the community of users within the ad hoc network. For example, units may group together and create an ad hoc method to barter incentives. Units may barter, volunteer, or trade incentives based on defined or negotiated context covering capability, battery life, airtime value ‘credit etc’ with other individual units or groups of units. For example, a first user may trade battery usage on the first user's device for air-time credits accumulated by a second user. That is, the first user can trade a communication resource for an incentive provided by a second user. As another example, one unit may be designated as the bartering ‘clearing house’. Alternatively, the method for bartering may be spread amongst a group of units or the entire community of units. For example—fire and police can barter incentives to share and optimize a delivery of packets within route. An incentive may be the sharing of battery life between units based on a location of the units and a second incentive may be the speed of delivery through the network. Understandably, the bartering of resources is not for a personal or financial gain, but for a collective incentive to share resources that provide a collective benefit to the bartering community.

In another arrangement, groups may form to collect credits to entice use of other groups or individuals to join their ad hoc system. In certain cases these communities may be grouped by message type, battery life, or capability—thus, creating an economic strata of communities that barter based on their value. As one example, low value groups can collect credits to barter with high value groups to create optimum routes for low value messages. Credits may also be provided to one unit that is holding out. For example, the entire community can assemble together and offer credits to one unit to entice the unit to join the community. For instance, the entire system may collect left over credits, credits volunteers, or ‘assessed’ credits to entice an important unit to join the ad hoc system. That is, the entire system can assess all units for credits to be redistributed to entice certain units to join for providing maximum benefit to the ad hoc community as a whole.

In one arrangement, a display can be included on a device screen which shows the number of nodes using the device for forwarding packets. For example, referring to FIG. 2, the display 118 can show the routes and costs of using the routes. Moreover, the display can show the credits the device accumulates for forwarding the packets. In this manner, the user can visually determine how many credits are available to the device and make a conscious decision in favor of (or against) switching off the device. Moreover, an IAP 106 can offer higher credit to a particular device if it is a critical link between other device s and the network. For example, the mobile device can identify costs for one or more routes in the ad-hoc network, displays the costs for the one or more routes, automatically ranks the one or more routes based on the cost; and automatically selects the route with the lowest cost. The cost can includes costs associated with bandwidth capacity, throughput, and security.

Referring back to FIG. 8, the method 800 can also include crediting (816) users based on a mode of use such as infrastructure mode or peer mode. That is, users can be charged based on a mode such as peer mode or infrastructure mode. Different rates can be assigned to the modes. Notably, infrastructure mode and peer mode correspond to different embodiments of ad hoc networking. For example, users can be charged a higher rate when their device is used in infrastructure mode. In particular certain offerings can be provided based on the mode. For example, in infrastructure mode, devices can be limited by number of bytes which they send or receive but can forward any number of packets for other users. In peer mode, on the other hand, the devices can also limited by number of bytes they forward. Understandably, this may prevent users from forming large networks where they replace Wireless Routers (WRs) with their own network devices thereby avoiding paying service fees to the service provider

For example if the device forwards packets in infrastructure mode, the user may receive credit which may be used in infrastructure mode. Similarly, the user can receive credit for operating the device in peer mode which may be used in peer mode. The service provider can also set an exchange rate for different credits. As one example, the credit given can be provided in the form of additional bytes which the user can exercise to send or receive data. As one example, an exchange system can be embedded within the transceiver 106 (See FIG. 2) that accounts for the number of packets forwarded. If there are multiple service providers in an area, the transceiver should maintain the number of packets forwarded for devices belonging to different service providers. This information should be periodically transmitted to the associated Intelligent Access Point (IAP) which should credit the device appropriately. The Intelligent Access Point can also charge the other service provider for the service provided by device/infrastructure belonging to it.

As another example, a billing rate can be adjusted depending on whether the mobile device, also referred to as unit, acknowledges ad hoc participation or not. For example, at initialization, a user can be billed if the user allows their mobile device to be a shared ad hoc communication resource. The billing rate can be adjusted in accordance with an actual usage of resources used on the unit. For example, the billing rate can be based on the number of packets forwarded by the unit. As another example, units may be billed at a higher rate in areas where the units are not participating in ad hoc networks (a pseudo ‘anti-roaming’ charge). Units may also join the network with contexts levels defined in their profiles. For example, contexts may determine the metrics (incentive/dis-incentives) the unit uses during collaboration in the ad hoc environment. In one aspect, the units may join the network with a predefined contexts levels for default contexts and negotiate the metrics dynamically. The method of determining these contexts and metrics can be predefined or dynamically defined and negotiated using a centralized or distributed approach.

Notably, the method 800 provides a means for generating continuous revenue to the service provider, helps make the network self-healing and self-balancing, and extends the range of the mesh by encouraging users to leave their devices in ad hoc mode (e.g. infrastructure mode or peer mode) even if the user is not using the device.

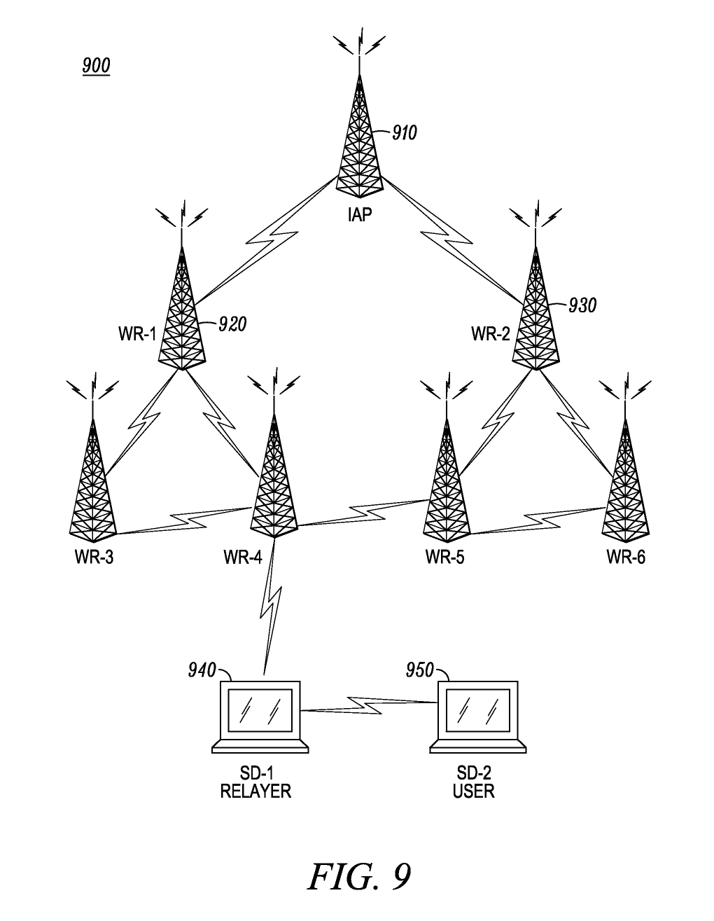

Briefly referring to FIG. 9, an ad hoc network 900 implementing the method 800 is shown. The ad hoc network 900 can include a plurality of service towers and devices. A first tower 910 may provide communication links between two separate networks. For example, a first network may be operated by tower 920, and a second network may be operated by tower 930. The first network 920 and the second network 930 may be operated by the same service provider or different service providers. In the latter, a device may have a subscription to the first network through the tower 910 and can be granted temporary access to the second network via the second tower 930. Notably, embodiments of the invention allow a user to migrate between networks without a service subscription agreement. The user can acquire credits when operating a device 940 in infrastructure mode, such as when the device communicates with the towers 920 or 930. Alternatively, the user can acquire credits when the device 940 is in ad hoc mode and only communicating with other devices, such as 950.

Moreover, FIG. 9 illustrates the relationship between devices to acquire network resources. For example, it can be seen that device 950 acquires network connectivity to network 920 through device 940. That is, device 940 is providing assistance to device 950. For example, device 940 can forward data packets to device 950 and receive credits in accordance with the rate credit accumulation previously described. Understandably, if a user of device 940 decides to switch off the device 940, the user of device 950 will be disconnected from the network. A handshake protocol can be implemented that precedes any attempt to switch off the transceiver 106 (See FIG. 2). The handshake protocol can disassociate the device 940 with the current network 820 and notify the network 840 or other networks 930 about possibly stranded devices, such as device 950. In such a situation the network 920 can send a special message to the device 940 offering it increased credit if it decides to stay on.

It should also be noted that another method for providing compensation to users and service providers can include micro-compensation. For example, just as credits can be offered based on a usage of resources or for forwarding packets, micro-compensation payment schemes can be implemented that provide users an alternate form of credit. In particular, micro-payment compensation can offer payments for resource usage in the form of cash. As one example, credit card companies can offer micro-payments to users for allowing their devices to be used as part of an ad hoc network. Micro-payments enable users and providers in an ad hoc network to provide compensation to other users. Moreover, micro-payments provide advantages over simple credit and debit schemes, since each user pays only for the amount of communication resources that he or she utilizes. In fact, users that primarily provide assistance to other users and rarely utilize resources themselves could accumulate a surplus of micro-payments that could be redeemed for cash, thus providing an incentive for them to continue to provide assistance to others.

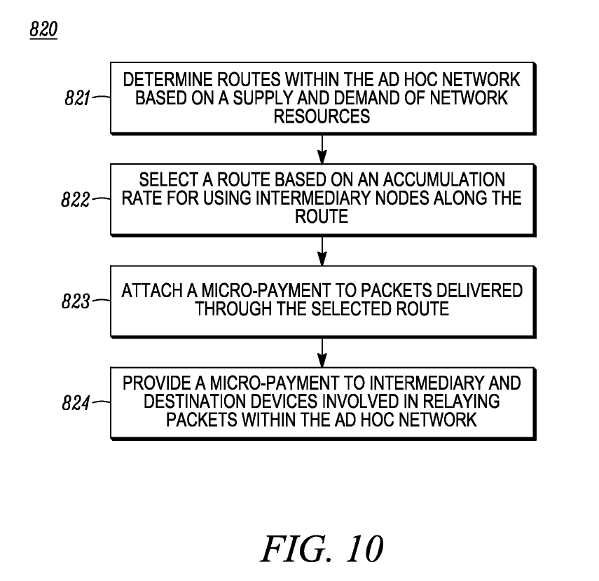

Accordingly, embodiments of the invention are also directed to a method of micro-payment for compensating users and service providers. For example, briefly referring to FIG. 10, a method 820 for micro-payment is shown. For example, micro-payments can be calculated based on a use of resources. The resources can include a battery life, a data capacity, a security, as previously presented in method step 310 of FIG. 3. The resources can also include infrastructure equipment resources for supporting communication in the ad hoc network corresponding to method step 420 in FIG. 4. It should also be noted that a micro-payment agreement on compensation rates can also be predetermined. For example, service providers or users can pre-arrange micro-payment compensation schemes.

The method 820 can start in a state wherein multiple devices are communicating within an ad hoc network and a node is attempting to deliver a packet. In practice, the method 820 can be utilized within a pure ad hoc network consisting only of mobile nodes. For example, referring to FIG. 1, only nodes 102 within the ad hoc network can originate and forward data packets to other nodes 102.

At step 821, routes within the ad hoc network can be determined based on a supply and demand of network resources. For example, the determination can be made based on credits charged by devices providing delivery support in the ad hoc network. For instance, a source node can request a route to a destination, wherein the cost of using the route is based on an accumulation of the costs for using each relay along the path. For example, the method step 814 of FIG. 8 for crediting a user based on a rate of packets generated or forwarded can be employed for evaluating route costs. The nodes that are one hop away from the source node sum the costs along the route and provide a total cost of utilizing the route to the source node. If multiple routes exist, then the costs of each route (along with other information such as throughput of the route, latency, etc.) are provided to the source node. It should be noted that multiple routes provide a foundation for a supply and demand based cost structure. Other alternatives, such as prior agreement on a cost structure (preferably as a function of resource utilization) are also herein contemplated.

At step 822, a route can be selected based on an accumulation rate for using intermediary nodes along the route. Briefly referring back to FIG. 8, the method step 814 for crediting a user can be employed to select a cost efficient route, wherein cost refers to an expense incurred for resource utilization. In practice, the cost for forwarding packets can be based on the actual amount of resource utilized, rather than an abstract measurement such as number of bits that may not reflect the true efficiency of a particular link. For example, a link with low propagation loss may enable transmission at very high bit rates, thus permitting reduced transmission time, lower transmit power, and the like. At step 823, a micro-payment can be attached to packets delivered through selected routes.

At step 824 micro-payments can be provided to intermediary and destination nodes along the route for receiving and transmitting data packets. For example, the source node can attach a header to a data packet identifying a compensation to be provided to intermediary nodes. The compensation may be a micro-payment that can be redeemed for cash, or an air-time credit that can be used for air-time. In another arrangement, the user may manually select the desired route, based on the cost and other factors. Selection of the route could also be performed autonomously by the source node device based on a user profile, e.g., lowest cost route, route with best match to desired throughput, route with best match to desired latency, and the like. Notably, each intermediate node receives the appropriate micro-payment(s) when relaying the packet(s) to the destination. Note: The source node is the preferred provider of micro-payments, but other alternatives are also possible such as micro-payments provided by the destination node, (analogous to a “collect call” in telephony).

In the foregoing, the addition of a single access provider to the pure ad hoc network previously described is considered; that is, a hybrid ad hoc network. For example, referring to FIG. 1, nodes 102 within the ad hoc network can originate and forward data packets to other nodes 102 and also a single access point 106 within the ad hoc network. When a source node (102) wishes to communicate via an access point (106), multiple routes to an access point may exist. The routes may include direct connection without use of intermediate nodes (102-n). Also, the last relay or link to the access point (106) of the multiple routes may utilize different amounts of resources at the access point (106), resulting in different costs. Understandably, the costs of each route are provided to the source node (102) and these costs reflect the different amounts of resources to be utilized at the access point (106), along with the costs of relaying between intermediate nodes (102-n). In a hybrid ad hoc network, the access point (106) receives micro-payments for the route that is utilized in a similar manner to the intermediate nodes (102-n). Communication through a single access point (106) may include additional services such as access to the internet, PSTN, or other services. In this scenario, the access point (106) may include the cost of these services in the total cost of utilizing a route. Thus, the cost of additional services may be included in the micro-payment scheme, thus potentially obviating the need for a subscription. That is, the cost of additional services can be bundled within the micro-payment scheme.

In the foregoing, a hybrid ad hoc network with multiple access points is considered. For example, referring to FIG. 1, nodes 102-n within the ad hoc network can originate and forward data packets to other nodes 102-n and multiple access points 106-n or routers 107-n within the ad hoc network. Notably, multiple routes exists to different access points and nodes. The method 700 for operation is the same as the other multiple route cases, except the access points 106-n will compete with each other. If the access points 106-n are owned by different entities, this a new level of competition is created. If network operators provide access points 106-n, then operators will compete against each other, based on supply and demand, preferably on a real-time basis or a packet-by-packet basis. Given supply and demand basis of operation, costs of utilizing different routes and access points 106-n may fluctuate based many factors. These factors include the number of available routes, number of available APs, number of available entities/operators, resources required for a particular route including battery state of intermediate nodes, current levels of traffic congestion, and the like.

Accordingly, aspects of the method 800 can be further extended to include costs through all intermediary nodes. That is, costs can be included to account for communication with the destination node including selected routes through a wireline network, a second AP, and other intermediate nodes. Again, given multiple routes to the destination, the total costs of multiple routes to the destination are accumulated based on the individual costs of relaying between intermediate nodes, access points, and network services, and micro-payments are received by the intermediaries for relaying the packet(s). As one example, if the destination node is served by a wireless network operator based on a subscription service, then the costs of communication through that wireless network are typically borne by the destination node and are excluded from the total micro-payment cost of utilizing that route.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for ad hoc networking, comprising:
compensating a first service provider for allowing a device of a second service provider to operate in an ad hoc network operated by the first service provider; and
determining network resources utilized for providing communication among nodes in the ad hoc network,
wherein the compensation to the first service provider provided by the second service provider accounts for network resources utilized by the device for communicating within the ad hoc network.

2. The method of claim 1, wherein the network resources equipment that is operated, owned, leased, rented, borrowed, or shared by the service provider.

3. The method of claim 2, wherein the equipment includes at least one of radios, cell phones, base stations, routers, access points, servers, and infrastructure equipment.

4. The method of claim 1, further comprising:
distributing credits to a plurality of service providers based on an amount of resources used by the device that are operated by the service providers.

5. The method of claim 4, further comprising:
determining a number of packets forwarded by the device; and
determining a number of packets originated by the device,
wherein the distributing credits is based on network resources used for forwarding packets and originating packets.

6. The method of claim 5, wherein the user is charged based on a number of packets the device of the user generates or receives in an area operated by a service provider.

7. The method of claim 1, further comprising:
providing a micro-payment to intermediary and destination nodes involved in relaying packets within the ad hoc network,
wherein the micro-payment is attached to a packet, sent with the packet, collected by the intermediary and destination nodes, and reported to the service provider.

8. The method of claim 7, wherein the providing a micro-payment further comprises:
incorporating a cost of a network service incurred by the device into the micro-payment.

9. The method of claim 7, further comprising:
including routing information within the micro-payment for allowing a service provider to determine what equipment has been utilized in forwarding the packet through the ad hoc network,
wherein the service provider can determine the amount of resources utilized for communicating the packet in the ad hoc network based on the routing information and receive compensation based on the resources utilized.

10. The method of claim 1, wherein the determining network resources includes:
identifying whether the device is operating in peer mode or infrastructure mode, and
if the device is in peer mode,
limiting a number of packets which the node sends and limiting a number of packets the node forwards,
if the device is in infrastructure mode,
limiting a number of packets which the node sends but not limiting a number of packets the node forwards.

11. The method of claim 10, further comprising:
providing infrastructure credits to the device for forwarding packets in infrastructure mode,
providing peer credits to the device for forwarding packets in peer mode,
establishing an exchange rate between the infrastructure credits and the peer credits,
providing credit to in the form of additional data capacity for sending or receiving packets based on an exchange rate of credit.

12. A method for compensation in an ad hoc network, comprising:
determining whether a first device of a first service provider is communicating through a second device of a second service provider;
charging the first service provider of the first device for allowing the first device to operate through the second device; and
compensating the second service provider for allowing the second device to provide communication assistance to the first device,
wherein the charging and compensating allow users to roam to different networks in the ad hoc network without a service subscription to the different networks

13. The method of claim 12, further comprising:
charging a first user of the first device a charge for allowing the first device to communicate through the second device and conveying the charge to the first service provider;
crediting a second user of the second device a credit that corresponds to the charge for allowing the second device to be used to provide communication assistance and conveying the credit to the second service provider,
wherein a first user of the first device credits a second user of the second device for allowing the first device of the first user to roam in a network of the second provider using the second device of the second user.

14. The method of claim 13, further comprising:
providing credits accumulated by a user to another service provider for allowing the user to roam to different networks in the ad hoc network without a service subscription to the different networks.

15. The method of claim 13, further comprising:
identifying connectivity nodes in the ad hoc network receiving network connectivity;
identifying dependent nodes in the ad hoc network receiving network connectivity through the connectivity nodes; and
offering connectivity nodes credits to remain connected in the ad hoc network for providing communication to the dependent nodes.

16. The method of claim 12, wherein the crediting a user includes:
adjusting a billing rate to the user based on a participation of the device in the ad hoc network.

17. The method of claim 12, wherein the crediting a user further comprises:
providing a micro-payment to intermediary and destination devices involved in relaying packets within the ad hoc network,
wherein the micro-payment is attached to a packet, sent with the packet, collected by the intermediary and destination devices, and reported to a service provider.

18. The method of claim 17, further comprising:
selling data capacity to the user in the form of credits and providing a key in response to a purchase of the data capacity;
dispensing the credits in accordance with an infrastructure mode or a peer mode; and
recharging the key based on a number of credits accumulated by the device,
wherein the recharging updates the micro-payment in accordance with a number of packets the device generates and receives.

19. A system for ad hoc networking, comprising
a plurality of mobile wireless user terminals for:
providing at least one incentive to a service provider for allowing a user to operate a device in an ad hoc network; and
distributing credits to a plurality of service providers based on an amount of resources used by the device that are operated by the service providers. and,
at least one service provider that provides network resources for supporting the ad hoc network,
compensates service providers for allowing mobile wireless user terminals to provide communication assistance to mobile wireless user terminals of the at least one service provider,
wherein the compensating allows users of the first service provider to roam to different networks in the ad hoc network without a service subscription to the different networks,
wherein the network resources include equipment that is operated, owned, leased, rented, borrowed, or shared by the service provider.

20. The method of claim 19, wherein the equipment includes at least one of radios, cell phones, base stations, routers, access points, servers, and infrastructure equipment.

21. An apparatus for providing compensation in an ad hoc network that
identifies connectivity nodes in the ad hoc network receiving network connectivity; and
offers the connectivity nodes credits to provide communication assistance for the apparatus by;
charging a first user of the apparatus a charge for communicating through a second device on a second service provider and conveying the charge to a first service provider of the apparatus, and
crediting a second user of the second device a credit that corresponds to the charge for allowing the second device to be used to provide communication assistance to the apparatus and conveying the credit to a second service provider of the second device,
wherein the charge depends on whether the apparatus is operating in peer mode or infrastructure mode.

22. The apparatus of claim 21, wherein the apparatus determines a packet forwarding route based on a credit charged by other nodes associated with the packet forwarding route,
wherein a credit to a device for forwarding packets is a micro-payment that is attached to a packet, sent with the packet, and collected by the connectivity nodes, and

23. The apparatus of claim 21, wherein the apparatus
provides an indication of the credits the apparatus accumulates as compensation for providing communication assistance to other nodes in the ad hoc network.

24. The apparatus of claim 21, wherein the apparatus
identifies costs for one or more routes in the ad-hoc network;
automatically ranks the one or more routes based on the cost; and
automatically selects the route with the lowest cost,
wherein the cost includes costs associated with bandwidth capacity, throughput, and security.

25. The apparatus of claim 24, wherein the apparatus further:
displays the costs for the one or more routes.
